(19) United States
(12) Patent Application Publication
(10) Pub. No.: US 2019/0279075 A1
(43) Pub. Date: Sep. 12, 2019

(54) MULTI-MODAL IMAGE TRANSLATION USING NEURAL NETWORKS

(71) Applicant: Nvidia Corporation, Santa Clara, CA (US)

(72) Inventors: Ming-Yu Liu, San Jose, CA (US); Xun Huang, New York, NY (US)

(21) Appl. No.: 16/279,671

(22) Filed: Feb. 19, 2019

Related U.S. Application Data
(60) Provisional application No. 62/641,210, filed on Mar. 9, 2018.

(51) Int. Cl. G06N 3/04; G06N 5/04; G06F 17/18; G06T 3/00

(52) U.S. Cl. CPC G06N 3/0454; G06N 5/04; G06T 3/0006; G06F 17/18; G06N 3/0472

(57) ABSTRACT

A source image is processed using an encoder network to determine a content code representative of a visual aspect of the source object represented in the source image. A target class is determined, which can correspond to an entire population of objects of a particular type. The user may specify specific objects within the target class, or a sampling can be done to select objects within the target class to use for the translation. Style codes for the selected target objects are determined that are representative of the appearance of those target objects. The target style codes are provided with the source content code as input to a translation network, which can use the codes to infer a set of images including representations of the selected target objects having the visual aspect determined from the source image.

### CROSS-REFERENCE TO RELATED APPLICATIONS

This application claims priority to U.S. Provisional Patent Application Ser. No. 62/641,210, filed Mar. 9, 2018, and entitled “System and Method for Multi-Modal Image-to-Image Translation,” which is hereby incorporate herein in its entirety for all purposes.

### BACKGROUND

Advances in processing power and image manipulation software have enabled an increasing variety of image creation and manipulation capabilities. For example, an image of a first type of object can be used to generate an image showing the first type of object having an aspect of a second type of object. In order to accomplish such generation, however, a user either has to manually generate or manipulate an image, or has to provide a large number of input images that enable adequate generation of the target image. Further, this process must be completed separately for each type of translation. This may be complex and time consuming in the case of manual generation, and may not be practical in situations where a user might only have limited images or resources.

### BRIEF DESCRIPTION OF THE DRAWINGS

Various embodiments in accordance with the present disclosure will be described with reference to the drawings, in which:

FIG. 1 illustrates an example image translation that can be performed in accordance with various embodiments.

FIGS. 2A and 2B illustrate example auto-coding and translation diagrams in accordance with various embodiments.

FIGS. 3A and 3B illustrate example translation approaches that can be utilized in accordance with various embodiments.

FIG. 4 illustrates an example encoding and decoding system that can be utilized in accordance with various embodiments.

FIG. 5 illustrates an example translation system that can be utilized in accordance with various embodiments.

FIG. 6 illustrates an example process for performing an image translation in accordance with various embodiments.

FIG. 7 illustrates an example system for translating images that can be utilized in accordance with various embodiments.

FIG. 8 illustrates another example image translation that can be performed in accordance with various embodiments.

FIG. 9 illustrates an example system for training an image synthesis network that can be utilized in accordance with various embodiments.

FIG. 10 illustrates layers of an example statistical model that can be utilized in accordance with various embodiments.

FIG. 11 illustrates example components of a computing device that can be used to implement aspects of the various embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Approaches in accordance with various embodiments provide for the generation of images including representations of objects having one or more specific visual aspects. In particular, various embodiments provide a translation framework that enables a visual aspect of an object in a source image to be applied to multiple objects of a target class, such that a set of images can be inferred that includes representations of those objects having the visual aspect. The source image can be processed using at least one encoder network, for example, that can determine a content code representative of the visual aspect of the source object, as well as a style code representative of a style or appearance of the object. In some embodiments these codes can be used to re-construct the source image to ensure accuracy of the codes.

A target class can also be determined, as may be specified by a user. The target class can correspond to an entire distribution or population of objects of a particular type or category. The user may specify specific objects within the target class, or a sampling can be done (i.e., a random sampling of the distribution performed) to select objects within the target class to use for the translation. Style codes for the selected target objects can be determined, similar to the style code that was generated for the source object. The target style codes can be provided with the source content code as input to a translation network, for example, which can use the codes to infer a set of images including representations of the selected target objects having the visual aspect determined from the source image.

Various other functions can be implemented within the various embodiments as well as discussed and suggested elsewhere herein.

As mentioned, a user or entity may wish to perform an image translation, where a visual aspect of one object can be applied to a different type of object. For example, a user might see a first type of animal in a specific pose that is of interest to the user. The user might want to generate, or obtain, an image of a different type of animal in that same pose. Using conventional approaches, the user would have to utilize image manipulation software that often required a significant amount of manual input. Such an approach can be very complicated and time consuming, and often the resulting image was not photorealistic.

The human brain is remarkably good at generalization. When given a picture of a type of animal, for example, the human brain can form a vivid mental picture of the animal in various poses, particularly when that human has been exposed to images or views of similar, but different, animals in those poses before. For example, a person seeing a standing pug will have little to no trouble imagining what a cat would look like in the same pose or position. While some conventional unsupervised image-to-image translation algorithms provide reasonable results in transferring complex appearance changes across image classes, the capability to generalize to an entire population of a class is not provided.

The development of machine learning has enabled various types of tasks to be learned by a neural network, for example. In some embodiments a neural network can be trained to perform an image translation, or to otherwise infer an image that is the result of combining aspects of a source image and a target image. In such an approach, however, the network may be trained for a specific type of object (e.g., a specific breed of cat or type of shoe). Thus, if a user wanted to obtain images of different types of object for comparison, or for another such purpose, the user would have to instruct separate translations using separate neural networks trained for the specific target object types, such as a network trained for lions and a network trained for tabby cats.

Approaches in accordance with various embodiments can provide for multi-modal image translation, where one or more visual aspects of a source object represented in a source image can be applied to different types of target objects in order to infer, through a single translation process, images of the visual aspect applied to multiple types of target objects. A multi-modal translation process as discussed herein can capture an entire distribution of objects within a class or category of objects, for example, without having to separately train networks for specific object types within a given class or category. In an animal example, a single neural network may be trained to represent the entire population of cats. In other embodiments, a single neural network may be trained to represent all animals that walk on four legs like cats, including dogs, horses, and the like. Various other approaches can be used as well, as may depend at least in part upon the type(s) of data used to train the network.

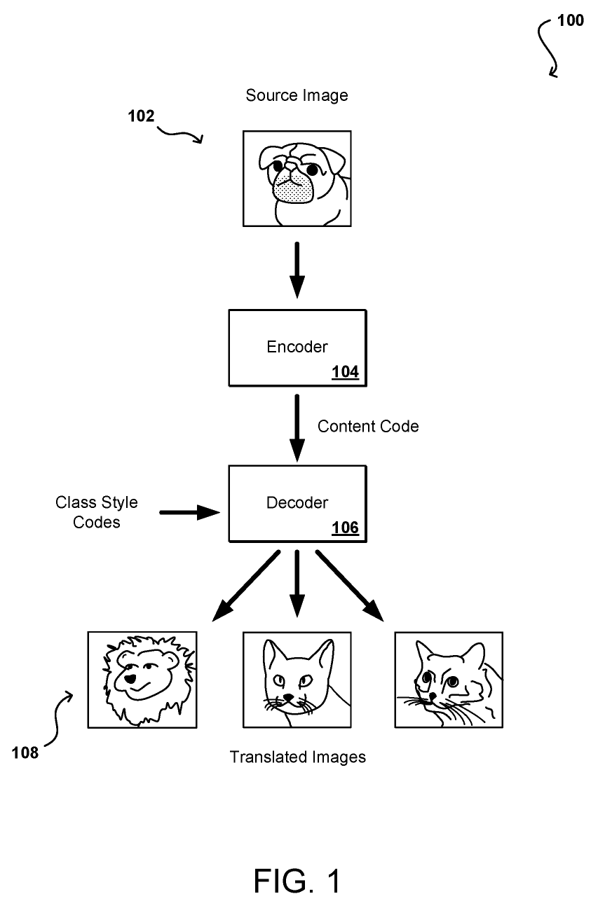

FIG. 1 illustrates an example image multi-modal translation 100 that can be performed in accordance with various embodiments. The translation can accept a source image 106 (or a digital representation of an image) as input, where the source image includes a representation of a type of object, in this case a dog. The user might like the pose of the dog in this image, the framing, or other visual aspects of the image. It might then be desired to generate or obtain images of other animals with that same visual aspect. For example, a user might want to obtain images with different types of cats exhibiting the visual aspect.

In this example, the source image 102 can be provided as input to an encoder 104, which as discussed herein can include one or more neural networks trained to extract information relating to the content and style of an input image. In this example, the encoder will extract a content code that is representative of the pose of the dog in the source image 102. As discussed elsewhere herein, however, various other types of visual aspects can be determined and associated with one or more content codes as well within the scope of the various embodiments. The networks will also extract a style code that is representative of the style of the object in the source image, in this example relating to the physical appearance of the dog. While the style code for the dog may not be used in the translation in at least some embodiments, the style code can be used with the content code for the dog to perform a decoding and reconstruction of the image of the dog. If the content code and style code were generated or inferred correctly, the reconstructed image using the style code and content code should very closely resemble the original source image. Approaches for determining the similarity or differences are discussed elsewhere herein. Further, various approaches for training neural networks and other machine learning models using relevant loss functions can be applied as well.

The content code, corresponding to the pose or other visual aspect of the dog in the source image 102 can be provided as input to a decoder 106, which can include another neural network in some embodiments for inferring images using the content code. Instead of the style code generated for the dog, however, style codes can be provided for the types of animals (or other objects) to which that pose is to be applied. This can include, for example, one or more types of animals specified for the translation, or can correspond to a sampling or subset of animals (or other objects) of a specified class or category, among other such options. In some embodiments a random sampling or multi-variate Gaussian distribution can be used to determine the types of animals (or other class objects) to use for the translation. Each of the animals can have had one or more images processed by an encoder 104 and decoder 106, as discussed herein, in order to generate style codes (or other style data) representative of those types of animals. For each selected type of animal in this example, a respective style code can be provided as input to the decoder 106. If three translation images are to be generated for three types of animals, then three respective style codes are provided to the decoder 106. The decoder can map or apply the style codes to the content code for use in generating, or inferring, a set of translated images 108, which each illustrate an animal of the respective target type in a pose of the source image, or having a visual aspect corresponding to the content code of the source image. As mentioned, these images can be generated using a single neural network as part of a single translation process, instead of requiring separate networks trained on the specific types of animals, where individual translations between the dog and the specific types of cats are required.

In some embodiments, the cats to be utilized for the translations will correspond to actual types of cats that have been used for the training. In some embodiments, each cat can be represented by a style point or vector in style space. The mapping of the different cats to a “feline style space” enables various interpolations to be performed, wherein any point in the feline style space can be selected and a style code determined, even if a cat of corresponding style was never utilized for training, or potentially even exists. This may include, for example, a cat that looks like a cross between a tiger and a leopard and has a corresponding representation in the style space. Each point can represent a valid cat, but with a specific style.

In various embodiments such an approach can be implemented using unsupervised translation. Unsupervised image-to-image translation can aim to learning the conditional distribution of target domain images given a source domain image without any paired supervision. This conditional distribution can be multi-modal, as an image in the source domain can be mapped to many different images in the target domain. Instead of modeling the translation using a one-to-one mapping of objects in the source and target domains, a Multimodal Unsupervised Image-to-image Translation (MUNIT) framework can be utilized that can generate diverse outputs from a given source domain image. In various embodiments, an image representation can be decomposed into a content code that is domain-invariant, as well as a style code that captures domain-specific properties. To translate an image to another domain, the content code for that image can be combined (or re-combined) with a style code selected from the style space of the target domain. This may be a specific selection, a random selection, or a selection according to a determined selection or sampling function, among other such options. An image translation framework in accordance with various embodiments can be based on a Generative Adversarial Networks (GAN), among other such networks, machine learning models, and options. An image translation framework in accordance with various embodiments can include a conditional image generator, G, and an adversarial discriminator, D.

Many problems in computer vision involve translating images from one domain to another, including super-resolution, colonization, in-painting. attribute transfer, and style transfer. This cross-domain image-to-image translation setting may therefore benefit significantly from improved methodology. When the dataset contains paired examples, this problem can be approached by a conditional generative model or a simple regression model. Such approaches do not, however, function properly in the much more challenging setting when such supervision is unavailable.

In various embodiments, the cross-domain mapping of interest is stochastic and multimodal. For example, a winter scene could have many possible appearances during summer due to factors such as weather, timing, or lighting. Unfortunately, existing techniques typically assume a deterministic or unimodal mapping. As a result, they fail to capture the full distribution of possible outputs. Even if the model is made stochastic by injecting random noise, the network typically will learn to ignore the random noise.

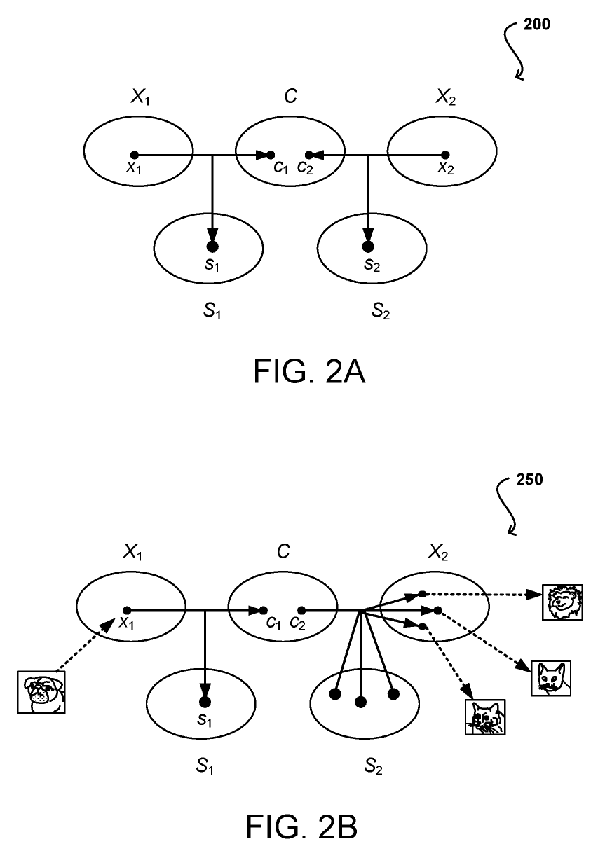

A MUNIT framework in accordance with various embodiments can be constructed using a number of assumptions. FIG. 2A illustrates one such set of assumptions 200 that can be utilized in accordance with various embodiments. In this example, a principled framework is generated with the assumption that the latent space of images in each domain can be decomposed into a content space and a style space. A further assumption can be that images in different domains share a common content space C, but have separate style spaces S₁ and S₂. Images in each domain X, are encoded to a shared content space C and a domain-specific style space Sᵢ. Each encoder has an inverse decoder omitted from this figure.

To translate an image from the source domain to the target domain, its content code can be combined with a random style code in the target style space, as shown in the diagram 250 of FIG. 2B. The content code for the source image encodes the information that should be preserved during translation, while the style code represents remaining variations that are not contained in the input image. By sampling different style codes in the target space, the model is able to concurrently produce diverse and multi-modal outputs, which can correspond to generated or inferred images as illustrated. To translate an image in X₁ (e.g., a dog) to X₂ (e.g., domestic cats), the content code of the source image can be re-combined with a random style code in the target style space(s). Different style codes lead to different outputs.

The assumptions for a multi-modal, unsupervised image-to-image translation framework in accordance with one embodiment can thus be given by the following. Let x₁ϵX₁ and x₂ϵX₂ be images from two different image domains. In the unsupervised image-to-image translation setting, samples can be drawn from two marginal distributions p(x₁) and p(x₂), without access to the joint distribution p(x₁, x₂). A goal in one embodiment is to estimate the two conditionals p(x₂|x₁) and p(x₁|x₂) with learned image-to-image translation models p(x₁ [symbol] ₂|x₁) and p(x₂ [symbol] ₁|x₂), where x₁ [symbol] ₂ is a sample produced by translating x₁ to X₂ (similar for x₂ [symbol] ₁). In general, p(x₂|x₁) and p(x₁|x₂) can be complex and multi-modal distributions, in which case a deterministic translation model would not perform sufficiently.

To tackle this problem, approaches in accordance with various embodiments can make a partially shared latent, space assumption. Specifically, it can be assumed that each image xᵢϵXᵢ is generated from a content latent code c E C that is shared by both domains, and a style latent code sᵢϵSᵢ that is specific to the individual domain. In other words, a pair of corresponding images (x₁, x₂) from the joint distribution is generated by x₁=G₁* (c, s₁) and x₂=G₂* (c, s₂), where c, s₁, and s₂ are from some prior distributions and G₁*, G₂* are the underlying generators. It can further be assumed that G₁* and G₂* are deterministic functions and have their inverse encoders E₁*=(G₁*⁻¹ and E₂*=(G₂*)⁻¹. In at least some embodiments, the underlying generator and encoder functions can be learned using neural networks. It should be noted that although the encoders and decoders are deterministic in various embodiments, p(x₂|x₁) is a continuous distribution due to the dependency of s₂. In various embodiments the content code takes the functional form of a high-dimensional spatial map that has a complex prior distribution instead of a simple independent Gaussian, since the content feature encodes the complex spatial structure of the data. The style codes, on the other hand, can take the form of low-dimensional vectors that can be modeled by Gaussian priors, since they have a global and relatively simple effect.

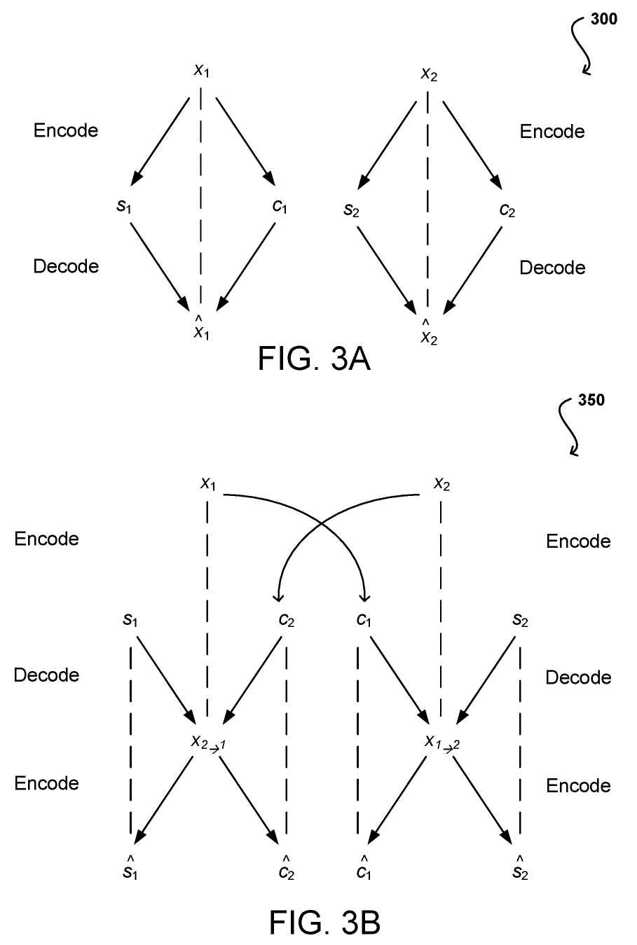

FIGS. 3A and 3B illustrate portions of an example model and learning process that can be utilized in accordance with various embodiments. The example translation model contains an encoder (i.e., an auto-encoder) and a decoder for each domain Xᵢ (i=1, 2). As illustrated in the example 300 of FIG. 3A, the latent code of each auto-encoder is factorized into a content code cᵢ and a style code sᵢ. Image-to-image translation is performed by swapping encoder-decoder pairs, as illustrated in FIG. 3B. For example, to translate an image xᵢϵX₁ to X₂, the content latent code c₁ is first extracted. A style latent code s₂ is randomly drawn or selected from the prior distribution. The second decoder (G₂) can then be used to produce the final output image X₂ [symbol] ₁=G₂ (c₁, s₂). Although the prior distribution is unimodal, the output image distribution can be multimodal thanks to the nonlinearity of the decoder. As discussed, the style codes s can represent, or be selected from, the entire distribution of objects in the target class.

A loss function can be utilized in various embodiments that has at least two components. One such component is the bidirectional reconstruction loss that ensures the encoders and decoders are inverses. To learn pairs of encoder and decoder that are inverses of each other, objective functions can be used that encourage reconstruction in both image→latent→image and latent→image→latent directions. For image reconstruction, an image sampled from the data distribution should be able to be reconstructed after encoding and decoding. For latent reconstruction, a latent code (style and content) sampled from the latent distribution at translation time should be able be reconstructed after decoding and encoding. The style reconstruction loss can have the effect of encouraging diverse outputs given different style codes. The content reconstruction loss, on the other hand, can encourage the translated image to preserve the semantic content of the input image. The other component is the adversarial loss that matches the distribution of translated images to images in the target domain. The adversarial loss can take advantage of a discriminator that tries to distinguish between translated images and real images in X₂.

In some embodiments, generative adversarial networks (GANs) can be used to match the distribution of translated images to the target data distribution. In other words, the images generated by the model should be indistinguishable from real images in the target domain in at least some embodiments. As mentioned, the latent code of each auto-encoder can be composed of a content code c and a style code s. The model can be trained with adversarial objectives that ensure the translated images to be indistinguishable from real images in the target domain, as well as bidirectional reconstruction objectives (represented by the dashed lines) that reconstruct both images and latent codes. The encoders, decoders, and discriminators can be trained jointly in some embodiments to optimize the final objective, which is a linear combination of the adversarial loss and the bidirectional reconstruction loss terms.

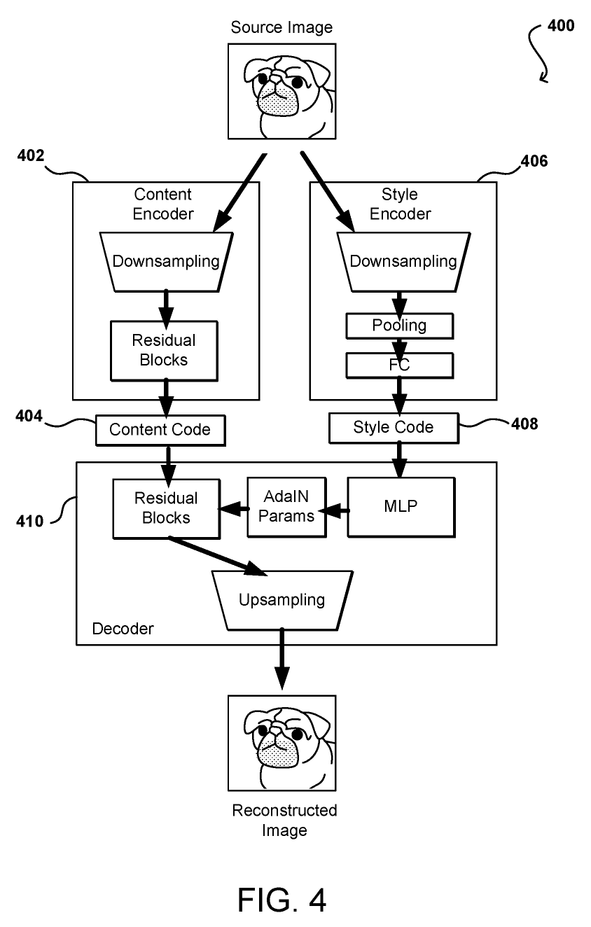

FIG. 4 illustrates an example network architecture of an auto-encoder 400 in one domain, which consists of a content encoder 402, a style encoder 406, and a joint decoder 410. In this example, the content encoder 402 consists of several strided convolutional layers to downsample the input and several residual blocks to further process it. All the convolutional layers are followed with Instance Normalization (IN). The style encoder 406 includes several strided convolutional layers, followed by a global average pooling layer and a fully connected (FC) layer. In at least some embodiments IN layers are not used in the style encoder, since IN removes the original feature mean and variance that represent important style information. The decoder 410 can reconstruct the input image from its content code and style code. The decoder can process the content code by a set of residual blocks and produce the reconstructed image using several up-sampling and convolutional layers. The residual blocks can be equipped with Adaptive Instance Normalization (AdaIN) layers whose parameters are dynamically generated by a multilayer perceptron (MLP) from the style code, as may utilize affine transformation parameters in normalization layers to represent styles. The affine parameters can be produced by a learned network, instead of computed from statistics of a pre-trained network, for example.

The architecture can also include a discriminator, such as the LSGAN objective which demonstrates better stability than DCGAN and trains faster than WGAN-GP. Multi-scale discriminators can be used to guide the generators to produce both realistic details and correct global structure.

The perceptual loss, often computed as a distance in the VGG feature space between the output and the reference image, has been shown to benefit image-to-image translation when paired supervision is available. In the unsupervised setting, however, there is not a reference image in the target domain. Thus, in some embodiments a modified version of perceptual loss can be used that is more domain-invariant, so that the input image can be used as the reference. Specifically, Instance Normalization can be performed before computing the distance, so the domain-specific information is largely removed. This has been found to be particularly useful on high-resolution datasets.

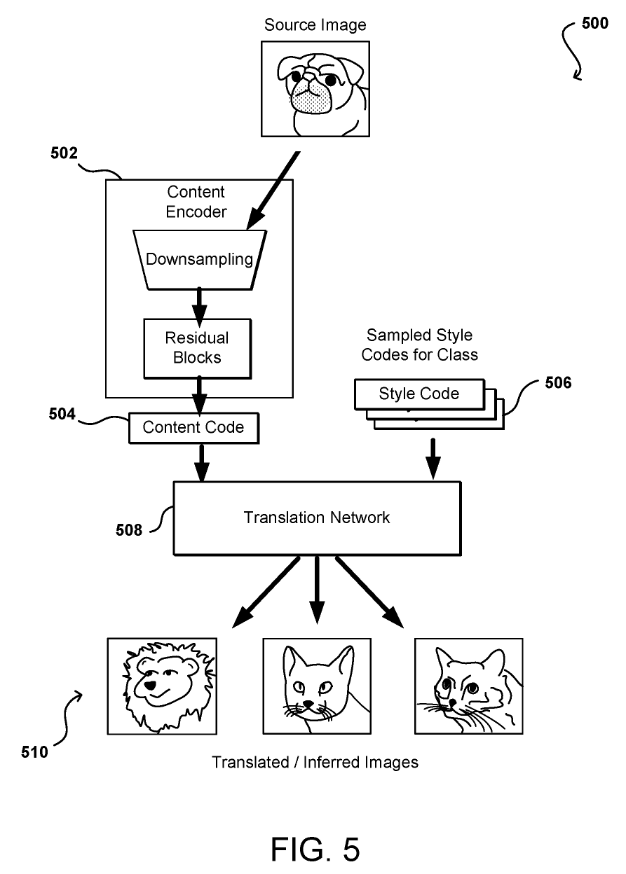

FIG. 5 illustrates another view of a transformation system 500 that can be used in accordance with various embodiments. In this example, a source image is received that includes a visual aspect to be used for image transformation. The image is again fed to a content encoder 502 for processing, in order to generate a content code 504 for the source image. Although not illustrated in this figure, a source-specific decoder could be used as well in order to take the content code and a style code generated for the source image and perform a reconstruction in order to verify the accuracy (or acceptable loss) of the content code for the source image.

In this example, a class of target objects has been determined, as may have been specified by a user providing or specifying the source image. A number of samples can be selected from the class, with each sample corresponding to an object of the class. In the present example, these samples refer to cats within a feline class. As mentioned, these can correspond to actual cats that have had training images processed, or can correspond to cats for values in the style space that may not have had training data processed. The sampling can be random, user-specified, or selected according to a sampling algorithm or function, among other such options. For the selected class samples, a set of style codes 506 can be provided. These may be stored in a library or generated from the point in style space, among other such options. The style codes 506 from the target class can be provided as input to the translation network 508 for processing. In some embodiments the translation network can include a trained neural network for inferring the translated images, while in other embodiments the translation network may include decoder and encoder networks as discussed with respect to FIG. 3B, among other such options. The translation network 508 can process the content and style codes as discussed herein, and can infer (or otherwise generate) a set of translated images 510 that each show one of the target cats, corresponding to the provided style codes, exhibiting the visual aspect of the source image. A second encoder may be used as well to generate the translated images as discussed elsewhere herein.

In various embodiments that utilize Multimodal Unsupervised Image-to-image Translation, the total loss can be minimized when the translated distribution matches the data distribution and the encoder-decoder are inverses. For image generation, combinations of auto-encoders and GANs can match the encoded latent distribution with the prior latent distribution at generation time, using either Kulback-Leibler Divergence (KLD) loss or adversarial loss in the latent space. After all, the auto-encode training would not help GAN training if the decoder receives a very different latent distribution at generation time. Although an objective function may not contain terms that explicitly encourage the match of latent distributions, it has the effect of matching them implicitly. At optimality, the encoded style distributions can match their Gaussian priors. Also, the encoded content distribution matches the distribution at generation time, which corresponds to the encoded distribution from the other domain. This suggests that the content space becomes domain-invariant.

Various embodiments also provide for joint distribution matching. An example model learns two conditional distributions which, together with the data distributions, define two joint distributions. Since both of them are designed to approximate the same underlying joint distribution, it can be desirable that they are consistent with each other. Joint distribution matching can provide an important constraint for unsupervised image-to-image translation and is behind the success of many recent methods. Here, models presented herein can match the joint distributions at optimality.

Approaches in accordance with various embodiments can also provide for style-augmented cycle consistency. Joint distribution matching can be realized via the cycle-consistency constraint, assuming deterministic translation models and matched marginals in at least some embodiments. However, this constraint may be too strong for multi-modal image translation. In fact, the translation model may degenerate to a deterministic function if cycle consistency is enforced in the supplementary material. Intuitively, style-augmented cycle consistency implies that if an image is translated to the target domain and then translated back using the original style, the original image should be obtained. Note that there is no use of explicit loss terms in some embodiments to enforce style-augmented cycle consistency, but it is implied by the proposed bidirectional reconstruction loss. It should be understood, however, that reconstruction is used primarily for regularization in various embodiments, and that other types of regularization can be used as well in other embodiments, or regularization may not be used in still other embodiments.

In some embodiments, the generator G consists of four primary components: a content encoder, a class encoder, an adaptive instance-norm (AdaIN) decoder, and an image decoder. Instance-norm and rectified linear units (ReLUs) can be applied to each convolutional and fully-connected layer of the network. The content encoder can contain several convolutional layers followed by several residual blocks. The content encoder can map an input content image, x, to a spatially distributed feature map z, referred to herein as the content latent code. The class encoder can comprise several convolutional layers followed by an average pooling layer. The average pooling layer can average activations first across spatial dimensions (e.g., height and width) and then across the set of images. The image decoder can comprise several AdaIN residual blocks followed by a couple of upscale convolutional layers. The AdaIN residual block can be a residual block using the AdaIN layer as the normalization layer. For each sample, the AdaIN layer (also referred to as a normalization layer) can first normalize the activations in each channel to a zero mean and unit variance distribution. The normalization layer can then transform the distribution, through a de-normalization process, to have specific mean and variance values. A primary goal of the image decoder is to decode the content code and the style code to generate a translation of the input content image. In some embodiments the AdaIN decoder is a multilayer perceptron. It decodes the content code to a set of mean and variance vectors that are used as the new means and variances for the respective channels in the respective AdaIN residual block in the image decoder. Using such a generator design, a class-invariant latent representation (e.g., an object pose) can be extracted using the content encoder, and an object-specific latent representation (e.g., an object style) can be extracted using the style encoder. By feeding the style code to the image decoder via the AdaIN layers, the style values are enabled to control the spatially invariant means and variances, while the source image determines the remaining information.

An example adversarial discriminator D is trained by solving multiple adversarial classification tasks simultaneously. The discriminator in some embodiments is a patch GAN discriminator that can render an output spatial map for an input image, where each entry in the map indicates the score for the corresponding patch in the input image. Each of the tasks to be solved can be a binary classification task in some embodiments, determining whether an input image to D is a real image of a source class or a translation output coming from the generator. As there are a number of classes, the discriminator can be designed to produce a corresponding number of outputs. When updating D for a real image of a class, D can be penalized if a certain output is negative. For a translation output yielding a fake image, D can be penalized if a corresponding output is positive. D may not be penalized for not predicting negatives for images of other classes. When updating the generator G, G may only be penalized if the specified output of D is negative. The discriminator D can be designed in some embodiments based on a class-conditional discriminator that consists of several residual blocks followed by a global average pooling layer. The feature produced by the global average pooling layer is called the discriminator feature, from which classification scores can be produced using linear mappings.

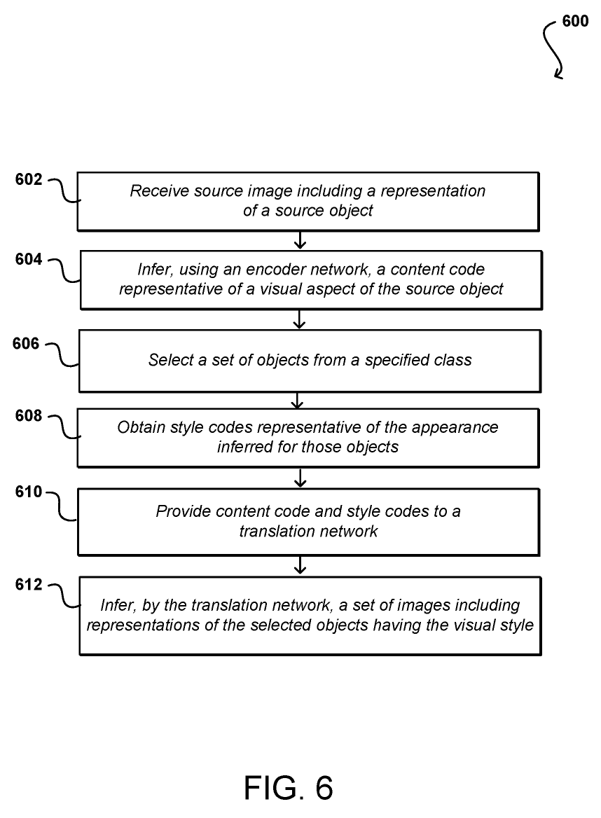

FIG. 6 illustrates an example process 600 for generating a set of image translations that can be utilized in accordance with various embodiments. It should be understood for this and other processes discussed herein that there can be additional, alternative, or fewer steps performed in similar or alternative orders, or in parallel, within the scope of the various embodiments unless otherwise stated. Further, while pose is used as a primary example of a visual aspect in various embodiments, there can be other aspects of the source image class that are utilized to generate transformations as discussed and suggested herein. In this example, an input digital image is received 602, or otherwise obtained or specified, that includes a representation of an object of interest. This can include, for example, the pose or view of the source object as represented in the source image. The source image can be processed using an encoder network, in this example, to infer 604 or otherwise determine a content code that is representative of the visual aspect.

In this example, it is desirable to generate a set of images of other objects of a class having the visual aspect. The class may be specified by a user or otherwise determined. A set of objects can be selected 606 from the sample class. This can include, for example, a user specifying one or more objects from the class. In other embodiments, this can include sampling from among a style space, whether at random or according to a sampling function, among other such options. A set of style codes can be determined that correspond to these objects. As mentioned, these style codes may have been determined previously using a similar process, or may be determined according to the mapping of the object into a style space generated for the class, etc. The content code for the source object and the style codes for the selected objects can be provided 610 to a translation network in order to generate the set of images. This can include one or more neural network as discussed herein that are able to apply the style of the target class objects to the visual aspect of the source object in the source image. A set of images can then be inferred 612 or otherwise generated by the translation network, where those images represent translations of the visual aspect onto objects of the target class, such as to cause a set of cats to appear to have the pose of a dog in a source image as discussed in examples herein.

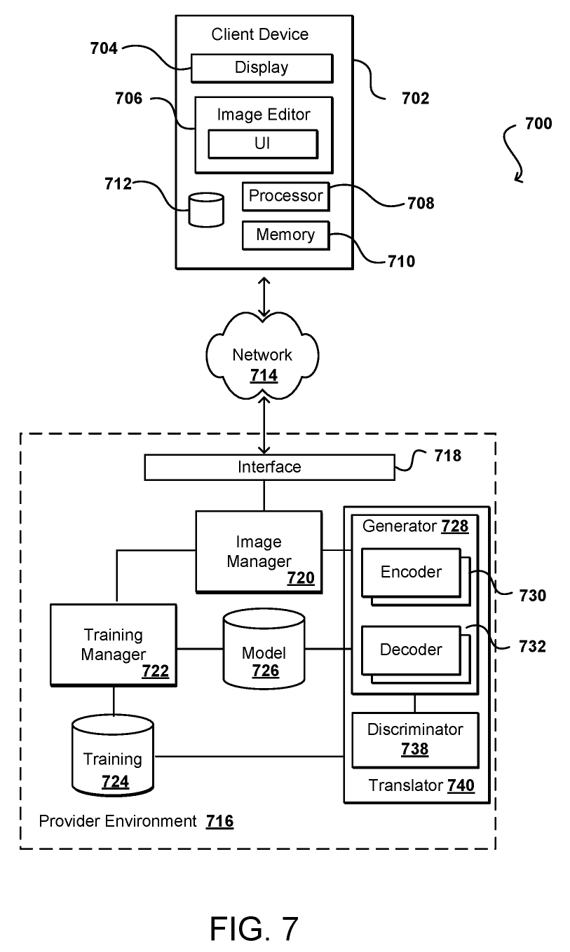

FIG. 7 illustrates an example environment 700 that can be utilized to implement aspects of the various embodiments. In some embodiments, a user may utilize a client device 702 to provide an input image, which may be an image including a representation of an object including a visual aspect of interest. The user may also utilize the client device to select an image indicating a visual aspect, such as a target pose, for which a translation is to be performed for the object in the input image. The client device can be any appropriate computing device capable of enabling a user to select and/or provide images for processing, such as may include a desktop computer, notebook computer, smart phone, tablet computer, computer workstation, gaming console, and the like. A user can select, provide, or otherwise specify the transformation input a user interface (UI) of an image editor application 706 (or other image manipulation or generation software package) running on the client device, although at least some functionality may also operate on a remote device, networked device, or in “the cloud” in some embodiments. The user can provide input to the UI, such as through a touch-sensitive display 704 or by moving a mouse cursor displayed on a display screen, among other such options. As mentioned, the user may be able to provide an input image of a target class, and may select one or more images of the target class representative of target objects to be utilized. The client device can include at least one processor 708 (e.g., a CPU or GPU) to execute the application and/or perform tasks on behalf of the application, and memory 710 for including the non-transitory computer-readable instructions for execution by the processor. Images provided to, or generated via, the application can be stored locally to local storage 712, such as a hard drive or flash memory, among other such options.

In some embodiments, input images received or selected on the client device 702 can be processed on the client device in order to generate an image with the desired translation, such as to apply the appearance of a target image to a pose extracted from a set of source images. In other embodiments, the client device 702 may send the input images, data extracted from the images, image codes, or data specifying the images over at least one network 714 to be received by a remote computing system, as may be part of a resource provider environment 716. The at least one network 714 can include any appropriate network, including an intranet, the Internet, a cellular network, a local area network (LAN), or any other such network or combination, and communication over the network can be enabled via wired and/or wireless connections. The provider environment 716 can include any appropriate components for receiving requests and returning information or performing actions in response to those requests. As an example, the provider environment might include Web servers and/or application servers for receiving and processing requests, then returning data or other content or information in response to the request.

Communications received to the provider environment 716 can be received to an interface layer 718. The interface layer 718 can include application programming interfaces (APIs) or other exposed interfaces enabling a user to submit requests to the provider environment. The interface layer 718 in this example can include other components as well, such as at least one Web server, routing components, load balancers, and the like. Components of the interface layer 718 can determine a type of request or communication, and can direct the request to the appropriate system or service. For example, if a communication is to train an image translation network for image content, the communication can be directed to an image manager 720, which can be a system or service provided using various resources of the provider environment 716. The communication, or information from the communication, can be directed to a training manager 724, which can select an appropriate model or network and then train the model using relevant training images and/or data 724. Once a network is trained and successfully evaluated, the network can be stored to a model repository 726, for example, that may store different models or networks for different types of image translation or processing. If a request is received to the interface layer 718 that includes input to be used for an image translation, information for the request can be directed to an image generator 728, also referred to herein as part of an image translation network or service, that can obtain the corresponding trained network, such as a trained generative adversarial network (GAN) as discussed herein, from the model repository 726 if not already stored locally to the generator 728. The image generator 728 can take as input the target image (or few images) and data indicating the visual aspect, as may be exhibited by a selected source image as discussed herein. The image generator 728 can then cause the input to be processed to generate an image representing the target transformation. As mentioned, this can involve the input being processed by the one or more encoders 730, or encoder networks. to extract a representation, such as may correspond to a code for the visual aspect. An encoder can also extract the visual style from an image of the target class. The codes can be fed to one or more decoders 732, such as an AdaIN decoder, which can decode the codes to a set of mean and variance vectors that are used as the new means and variances for the respective channels in the respective AdaIN residual block in the decoder. The generated image can be transmitted to the client device 702 for display on the display element 704, or for other such usage. If the user wants to modify any aspects of the image, the user can provide additional input to the application 706, which can cause a new or updated image to be generated using the same process for the new or updated input, such as an additional image of the target class or specification of a different pose, among other such options. In some embodiments, an image generation network can utilize a deep generative model that can learn to sample images given a training dataset. The models used can include, for example, generative adversarial networks (GANs) and variational auto-encoder (VAE) networks while aiming for an image translation task. An image translation network, or translator 736, can comprise a GAN in various embodiments that consists of a generator 728 and a discriminator 734. The generator 728 can be used to produce translated images so that the discriminator cannot differentiate between real and generated.

In various embodiments the processor 708 (or a processor of the training manager 722 or image translator 736) will be a central processing unit (CPU). As mentioned, however, resources in such environments can utilize GPUs to process data for at least certain types of requests. With thousands of cores, GPUs are designed to handle substantial parallel workloads and, therefore, have become popular in deep learning for training neural networks and generating predictions. While the use of GPUs for offline builds has enabled faster training of larger and more complex models, generating predictions offline implies that either request-time input features cannot be used or predictions must be generated for all permutations of features and stored in a lookup table to serve real-time requests. If the deep learning framework supports a CPU-mode and the model is small and simple enough to perform a feed-forward on the CPU with a reasonable latency, then a service on a CPU instance could host the model. In this case, training can be done offline on the GPU and inference done in real-time on the CPU. If the CPU approach is not a viable option, then the service can run on a GPU instance. Because GPUs have different performance and cost characteristics than CPUs, however, running a service that offloads the runtime algorithm to the GPU can require it to be designed differently from a CPU based service.

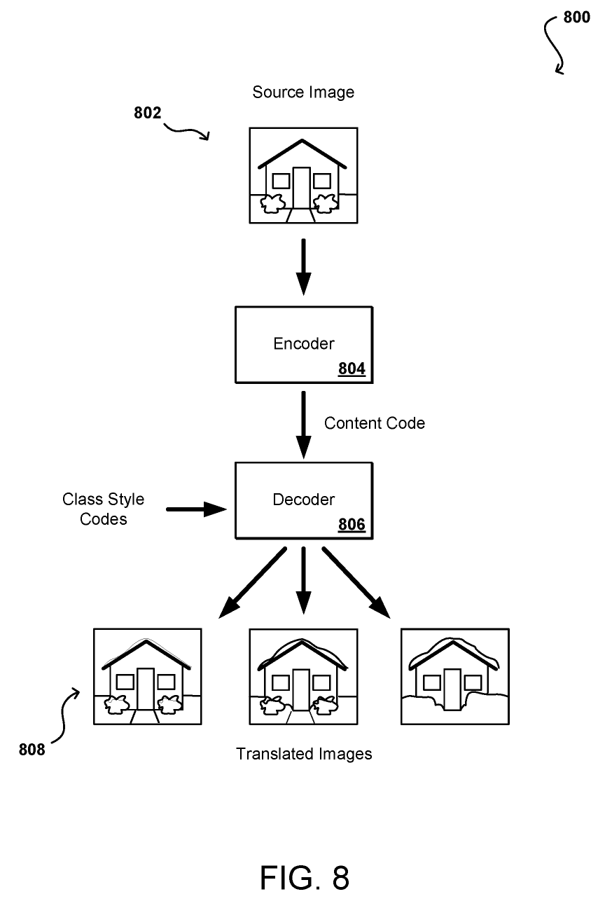

FIG. 8 illustrates another example translation 800 that can be performed in accordance with various embodiments. In this example, the source image 802 corresponds to a view of a scene. The target class can correspond to different levels of snow exhibited in winter. Accordingly, the source image 802 can be passed to an encoder 804 that can analyze the source image to infer a content code that is representative of the visual aspect(s) determined for the source image. The content code can be fed to a decoder 806 in this example, which can also receive a set of class style codes. As mentioned, the class may cover the entire spectrum or distribution of snow levels, and the codes may correspond to a sampling of those levels. The decoder 806 can utilize the content code with the style codes to generate or infer a set of translated images 808, where each image includes a representation of the object in the source image with levels of snow corresponding to the class style codes that were selected.

Various other types of translations can be performed as well using approaches within the scope of the various embodiments. For example, a user might be able to utilize and image editing application to draw an image of a shoe in a particular pose or view. The user alternatively might be able to obtain an image including such a drawing or creation. The image can be used as a source image that can be provided to the translation framework in order to determine a visual aspect of the created object to be used for the translation. If the target class is a class of shoes, then style codes can be selected that can cause the pose of the source shoe to be used to generate images that have the style of actual shoes applied, enabling the user to create new shoes that may not otherwise exist. Various other types of translations can be performed as well, as would be apparent to one of ordinary skill in the art in light of the teachings and suggestions contained herein.

As mentioned, various embodiments take advantage of machine learning. As an example, deep neural networks (DNNs) developed on processors have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features is assigned a certain weight based on the importance of that feature in defining the shape of an object.

A deep neural network (DNN) model includes multiple layers of many connected perceptrons (e.g., nodes) that can be trained with enormous amounts of input data to quickly solve complex problems with high accuracy, in one example, a first layer of the DLL model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand. Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported. Inferencing is less compute-intensive than training, being a latency-sensitive process where a trained neural network is applied to new inputs it has not seen before to classify images, translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, a computing platform can deliver performance required for deep neural network-based artificial intelligence and machine learning applications.

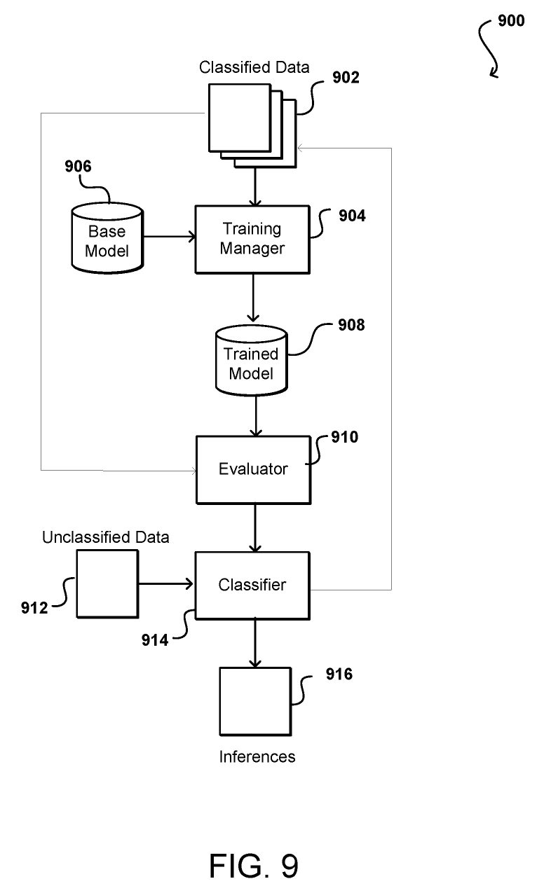

FIG. 9 illustrates an example system 900 that can be used to classify data, or generate inferences, in accordance with various embodiments. Various predictions, labels, or other outputs can be generated for input data as well, as should be apparent in light of the teachings and suggestions contained herein. Further, both supervised and unsupervised training can be used in various embodiments discussed herein. In this example, a set of classified data 902 is provided as input to function as training data. The classified data can include instances of at least one type of object for which a statistical model is to be trained, as well as information that identifies that type of object. For example, the classified data might include a set of images that each includes a representation of a type of object, where each image also includes, or is associated with, a label, metadata, classification, or other piece of information identifying the type of object represented in the respective image. Various other types of data may be used as training data as well, as may include text data, audio data, video data, and the like. The classified data 902 in this example is provided as training input to a training manager 904. The training manager 904 can be a system or service that includes hardware and software, such as one or more computing devices executing a training application, for training the statistical model. In this example, the training manager 904 will receive an instruction or request indicating a type of model to be used for the training. The model can be any appropriate statistical model, network, or algorithm useful for such purposes, as may include an artificial neural network, deep learning algorithm, learning classifier, Bayesian network, and the like. The training manager 904 can select a base model, or other untrained model, from an appropriate repository 906 and utilize the classified data 902 to train the model, generating a trained model 908 that can be used to classify similar types of data. In some embodiments where classified data is not used, the appropriate based model can still be selected for training on the input data per the training manager.

The model can be trained in a number of different ways, as may depend in part upon the type of model selected. For example, in one embodiment a machine learning algorithm can be provided with a set of training data, where the model is a model artifact created by the training process. Each instance of training data contains the correct answer (e.g., classification), which can be referred to as a target or target attribute. The learning algorithm finds patterns in the training data that map the input data attributes to the target, the answer to be predicted, and a machine learning model is output that captures these patterns. The machine learning model can then be used to obtain predictions on new data for which the target is not specified.

In one example, a training manager can select from a set of machine learning models including binary classification, multiclass classification, and regression models. The type of model to be used can depend at least in part upon the type of target to be predicted. Machine learning models for binary classification problems predict a binary outcome, such as one of two possible classes. A learning algorithm such as logistic regression can be used to train binary classification models. Machine learning models for multiclass classification problems allow predictions to be generated for multiple classes, such as to predict one of more than two outcomes. Multinomial logistic regression can be useful for training multiclass models. Machine learning models for regression problems predict a numeric value. Linear regression can be useful for training regression models.

In order to train a machine learning model in accordance with one embodiment, the training manager must determine the input training data source, as well as other information such as the name of the data attribute that contains the target to be predicted, required data transformation instructions, and training parameters to control the learning algorithm. During the training process, a training manager in some embodiments may automatically select the appropriate learning algorithm based on the type of target specified in the training data source. Machine learning algorithms can accept parameters used to control certain properties of the training process and of the resulting machine learning model. These are referred to herein as training parameters. If no training parameters are specified, the training manager can utilize default values that are known to work well for a large range of machine learning tasks. Examples of training parameters for which values can be specified include the maximum model size, maximum number of passes over training data, shuffle type, regularization type, learning rate, and regularization amount. Default settings may be specified, with options to adjust the values to fine-tune performance.

The maximum model size is the total size, in units of bytes, of patterns that are created during the training of model. A model may be created of a specified size by default, such as a model of 100 MB. If the training manager is unable to determine enough patterns to fill the model size, a smaller model may be created. If the training manager finds more patterns than will fit into the specified size, a maximum cut-off may be enforced by trimming the patterns that least affect the quality of the learned model. Choosing the model size provides for control of the trade-off between the predictive quality of a model and the cost of use. Smaller models can cause the training manager to remove many patterns to fit within the maximum size limit, affecting the quality of predictions. Larger models, on the other hand, may cost more to query for real-time predictions. Larger input data sets do not necessarily result in larger models because models store patterns, not input data; if the patterns are few and simple, the resulting model will be small. Input data that has a large number of raw attributes (input columns) or derived features (outputs of the data transformations) will likely have more patterns found and stored during the training process.

In some embodiments, the training manager can make multiple passes or iterations over the training data to discover patterns. There may be a default number of passes, such as ten passes, while in some embodiments up to a maximum number of passes may be set, such as up to one hundred passes. In some embodiments there may be no maximum set, or there may be a convergence or other criterion set which will trigger an end to the training process. In some embodiments the training manager can monitor the quality of patterns (i.e., the model convergence) during training, and can automatically stop the training when there are no more data points or patterns to discover. Data sets with only a few observations may require more passes over the data to obtain higher model quality. Larger data sets may contain many similar data points, which can reduce the need for a large number of passes. The potential impact of choosing more data passes over the data is that the model training can takes longer and cost more in terms of resources and system utilization.

In some embodiments the training data is shuffled before training, or between passes of the training. The shuffling in many embodiments is a random or pseudo-random shuffling to generate a truly random ordering, although there may be some constraints in place to ensure that there is no grouping of certain types of data, or the shuffled data may be reshuffled if such grouping exists, etc. Shuffling changes the order or arrangement in which the data is utilized for training so that the training algorithm does not encounter groupings of similar types of data, or a single type of data for too many observations in succession. For example, a model might be trained to predict a product type, where the training data includes movie, toy, and video game product types. The data might be sorted by product type before uploading. The algorithm can then process the data alphabetically by product type, seeing only data for a type such as movies first. The model will begin to learn patterns for movies. The model will then encounter only data for a different product type, such as toys, and will try to adjust the model to fit the toy product type, which can degrade the patterns that fit movies. This sudden switch from movie to toy type can produce a model that does not learn how to predict product types accurately. Shuffling can be performed in some embodiments before the training data set is split into training and evaluation subsets, such that a relatively even distribution of data types is utilized for both stages. In some embodiments the training manager can automatically shuffle the data using, for example, a pseudo-random shuffling technique.

When creating a machine learning model, the training manager in some embodiments can enable a user to specify settings or apply custom options. For example, a user may specify one or more evaluation settings, indicating a portion of the input data to be reserved for evaluating the predictive quality of the machine learning model. The user may specify a recipe that indicates which attributes and attribute transformations are available for model training. The user may also specify various training parameters that control certain properties of the training process and of the resulting model.

Once the training manager has determined that training of the model is complete, such as by using at least one end criterion discussed herein, the trained model 908 can be provided for use by a classifier 914 in classifying unclassified data 912. In many embodiments, however, the trained model 908 will first be passed to an evaluator 910, which may include an application or process executing on at least one computing resource for evaluating the quality (or another such aspect) of the trained model. The model is evaluated to determine whether the model will provide at least a minimum acceptable or threshold level of performance in predicting the target on new and future data. Since future data instances will often have unknown target values, it can be desirable to check an accuracy metric of the machine learning on data for which the target answer is known, and use this assessment as a proxy for predictive accuracy on future data.

In some embodiments, a model is evaluated using a subset of the classified data 902 that was provided for training. The subset can be determined using a shuffle and split approach as discussed above. This evaluation data subset will be labeled with the target, and thus can act as a source of ground truth for evaluation. Evaluating the predictive accuracy of a machine learning model with the same data that was used for training is not useful, as positive evaluations might be generated for models that remember the training data instead of generalizing from it. Once training has completed, the evaluation data subset is processed using the trained model 908 and the evaluator 910 can determine the accuracy of the model by comparing the ground truth data against the corresponding output (or predictions/observations) of the model. The evaluator 910 in some embodiments can provide a summary or performance metric indicating how well the predicted and true values match. If the trained model does not satisfy at least a minimum performance criterion, or other such accuracy threshold, then the training manager 904 can be instructed to perform further training, or in some instances try training a new or different model, among other such options. If the trained model 908 satisfies the relevant criteria, then the trained model can be provided for use by the classifier 914.

When creating and training a machine learning model, it can be desirable in at least some embodiments to specify model settings or training parameters that will result in a model capable of making the most accurate predictions. Example parameters include the number of passes to be performed (forward and/or backward), regularization, model size, and shuffle type. As mentioned, however, selecting model parameter settings that produce the best predictive performance on the evaluation data might result in an overfitting of the model. Overfitting occurs when a model has memorized patterns that occur in the training and evaluation data sources, but has failed to generalize the patterns in the data. Overfitting often occurs when the training data includes all of the data used in the evaluation. A model that has been over fit may perform well during evaluation, but may fail to make accurate predictions on new or otherwise unclassified data. To avoid selecting an over fitted model as the best model, the training manager can reserve additional data to validate the performance of the model. For example, the training data set might be divided into 60 percent for training, and 40 percent for evaluation or validation, which may be divided into two or more stages. After selecting the model parameters that work well for the evaluation data, leading to convergence on a subset of the validation data, such as half the validation data, a second validation may be executed with a remainder of the validation data to ensure the performance of the model. If the model meets expectations on the validation data, then the model is not overfitting the data. Alternatively, a test set or held-out set may be used for testing the parameters. Using a second validation or testing step helps to select appropriate model parameters to prevent overfitting. However, holding out more data from the training process for validation makes less data available for training. This may be problematic with smaller data sets as there may not be sufficient data available for training. One approach in such a situation is to perform cross-validation as discussed elsewhere herein.

There are many metrics or insights that can be used to review and evaluate the predictive accuracy of a given model. One example evaluation outcome contains a prediction accuracy metric to report on the overall success of the model, as well as visualizations to help explore the accuracy of the model beyond the prediction accuracy metric. The outcome can also provide an ability to review the impact of setting a score threshold, such as for binary classification, and can generate alerts on criteria to check the validity of the evaluation. The choice of the metric and visualization can depend at least in part upon the type of model being evaluated.

Once trained and evaluated satisfactorily, the trained machine learning model can be used to build or support a machine learning application. In one embodiment building a machine learning application is an iterative process that involves a sequence of steps. The core machine learning problem(s) can be framed in terms of what is observed and what answer the model is to predict. Data can then be collected, cleaned, and prepared to make the data suitable for consumption by machine learning model training algorithms. The data can be visualized and analyzed to run sanity checks to validate the quality of the data and to understand the data. It might be the case that the raw data (e.g., input variables) and answer (e.g., the target) are not represented in a way that can be used to train a highly predictive model. Therefore, it may be desirable to construct more predictive input representations or features from the raw variables. The resulting features can be fed to the learning algorithm to build models and evaluate the quality of the models on data that was held out from model building. The model can then be used to generate predictions of the target answer for new data instances.

In the example system 900 of FIG. 9, the trained model 910 after evaluation is provided, or made available, to a classifier 914 that is able to use the trained model to process unclassified data. This may include, for example, data received from users or third parties that are not classified, such as query images that are looking for information about what is represented in those images. The unclassified data can be processed by the classifier using the trained model, and the results 916 (i.e., the classifications or predictions) that are produced can be sent back to the respective sources or otherwise processed or stored. In some embodiments, and where such usage is permitted, the now classified data instances can be stored to the classified data repository, which can be used for further training of the trained model 908 by the training manager. In some embodiments the model will be continually trained as new data is available, but in other embodiments the models will be retrained periodically, such as once a day or week, depending upon factors such as the size of the data set or complexity of the model.

The classifier can include appropriate hardware and software for processing the unclassified data using the trained model. In some instances the classifier will include one or more computer servers each having one or more graphics processing units (GPUs) that are able to process the data. The configuration and design of GPUs can make them more desirable to use in processing machine learning data than CPUs or other such components. The trained model in some embodiments can be loaded into GPU memory and a received data instance provided to the GPU for processing. GPUs can have a much larger number of cores than CPUs, and the GPU cores can also be much less complex. Accordingly, a given GPU may be able to process thousands of data instances concurrently via different hardware threads. A GPU can also be configured to maximize floating point throughput, which can provide significant additional processing advantages for a large data set.

Even when using GPUs, accelerators, and other such hardware to accelerate tasks such as the training of a model or classification of data using such a model, such tasks can still require significant time, resource allocation, and cost. For example, if the machine learning model is to be trained using 100 passes, and the data set includes 1,000,000 data instances to be used for training, then all million instances would need to be processed for each pass. Different portions of the architecture can also be supported by different types of devices. For example, training may be performed using a set of servers at a logically centralized location, as may be offered as a service, while classification of raw data may be performed by such a service or on a client device, among other such options. These devices may also be owned, operated, or controlled by the same entity or multiple entities in various embodiments.

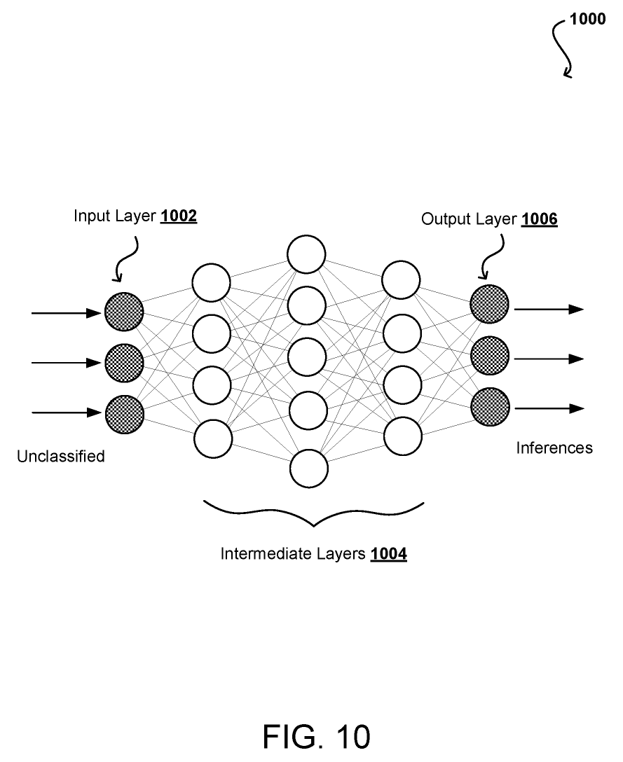

FIG. 10 illustrates an example neural network 1000, or other statistical model, that can be utilized in accordance with various embodiments. In this example the statistical model is an artificial neural network (ANN) that includes a multiple layers of nodes, including an input layer 1002, an output layer 1006, and multiple layers 1004 of intermediate nodes, often referred to as “hidden” layers, as the internal layers and nodes are typically not visible or accessible in conventional neural networks. As discussed elsewhere herein, there can be additional types of statistical models used as well, as well as other types of neural networks including other numbers of selections of nodes and layers, among other such options. In this network, all nodes of a given layer are interconnected to all nodes of an adjacent layer. As illustrated, the nodes of an intermediate layer will then each be connected to nodes of two adjacent layers. The nodes are also referred to as neurons or connected units in some models, and connections between nodes are referred to as edges. Each node can perform a function for the inputs received, such as by using a specified function. Nodes and edges can obtain different weightings during training, and individual layers of nodes can perform specific types of transformations on the received input, where those transformations can also be learned or adjusted during training. The learning can be supervised or unsupervised learning, as may depend at least in part upon the type of information contained in the training data set. Various types of neural networks can be utilized, as may include a convolutional neural network (CNN) that includes a number of convolutional layers and a set of pooling layers, and have proven to be beneficial for applications such as image recognition. CNNs can also be easier to train than other networks due to a relatively small number of parameters to be determined.

In some embodiments, such a complex machine learning model can be trained using various tuning parameters. Choosing the parameters, fitting the model, and evaluating the model are parts of the model tuning process, often referred to as hyperparameter optimization. Such tuning can involve introspecting the underlying model or data in at least some embodiments. In a training or production setting, a robust workflow can be important to avoid overfitting of the hyperparameters as discussed elsewhere herein. Cross-validation and adding Gaussian noise to the training dataset are techniques that can be useful for avoiding overfitting to any one dataset. For hyperparameter optimization it may be desirable in some embodiments to keep the training and validation sets fixed. In some embodiments, hyperparameters can be tuned in certain categories, as may include data preprocessing (in other words, translating words to vectors), CNN architecture definition (for example, filter sizes, number of filters), stochastic gradient descent parameters (for example, learning rate), and regularization (for example, dropout probability), among other such options.

In an example pre-processing step, instances of a dataset can be embedded into a lower dimensional space of a certain size. The size of this space is a parameter to be tuned. The architecture of the CNN contains many tunable parameters. A parameter for filter sizes can represent an interpretation of the information that corresponds to the size of a instance that will be analyzed. In computational linguistics, this is known as the n-gram size. An example CNN uses three different filter sizes, which represent potentially different n-gram sizes. The number of filters per filter size can correspond to the depth of the filter. Each filter attempts to learn something different from the structure of the instance, such as the sentence structure for textual data. In the convolutional layer, the activation function can be a rectified linear unit and the pooling type set as max pooling. The results can then be concatenated into a single dimensional vector, and the last layer is fully connected onto a two-dimensional output. This corresponds to the binary classification to which an optimization function can be applied. One such function is an implementation of a Root Mean Square (RMS) propagation method of gradient descent, where example hyperparameters can include learning rate, batch size, maximum gradient normal, and epochs. With neural networks, regularization can be an extremely important consideration.

As mentioned, in some embodiments the input data may be relatively sparse. A main hyperparameter in such a situation can be the dropout at the penultimate layer, which represents a proportion of the nodes that will not “fire” at each training cycle. An example training process can suggest different hyperparameter configurations based on feedback for the performance of previous configurations. The model can be trained with a proposed configuration, evaluated on a designated validation set, and the performance reporting. This process can be repeated to, for example, trade off exploration (learning more about different configurations) and exploitation (leveraging previous knowledge to achieve better results).

As training CNNs can be parallelized and GPU-enabled computing resources can be utilized, multiple optimization strategies can be attempted for different scenarios. A complex scenario allows tuning the model architecture and the preprocessing and stochastic gradient descent parameters. This expands the model configuration space. In a basic scenario, only the preprocessing and stochastic gradient descent parameters are tuned. There can be a greater number of configuration parameters in the complex scenario than in the basic scenario. The tuning in a joint space can be performed using a linear or exponential number of steps, iteration through the optimization loop for the models. The cost for such a tuning process can be significantly less than for tuning processes such as random search and grid search, without any significant performance loss.

Some embodiments can utilize backpropagation to calculate a gradient used for determining the weights for the neural network. Backpropagation is a form of differentiation, and can be used by a gradient descent optimization algorithm to adjust the weights applied to the various nodes or neurons as discussed above. The weights can be determined in some embodiments using the gradient of the relevant loss function. Backpropagation can utilize the derivative of the loss function with respect to the output generated by the statistical model. As mentioned, the various nodes can have associated activation functions that define the output of the respective nodes. Various activation functions can be used as appropriate, as may include radial basis functions (RBFs) and sigmoids, which can be utilized by various support vector machines (SVMs) for transformation of the data. The activation function of an intermediate layer of nodes is referred to herein as the inner product kernel. These functions can include, for example, identity functions, step functions, sigmoidal functions, ramp functions, and the like. Activation functions can also be linear or non-linear, among other such options.

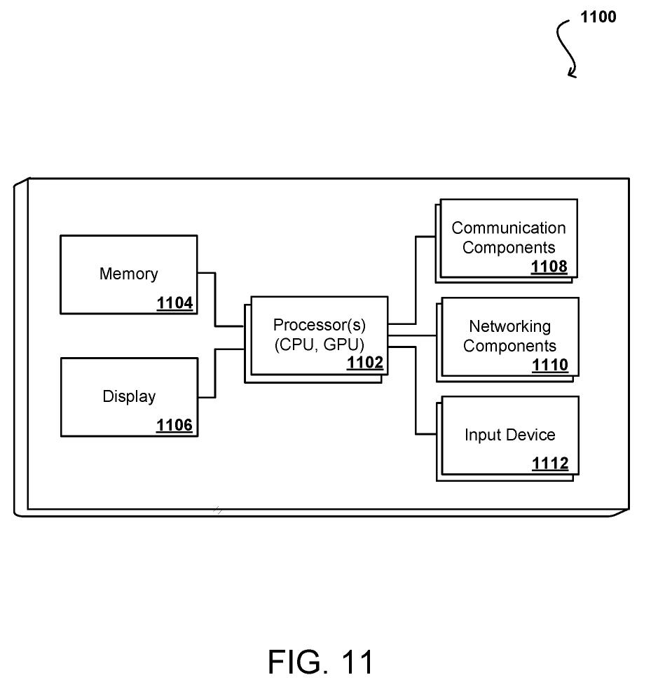

FIG. 11 illustrates a set of basic components of a computing device 1100 that can be utilized to implement aspects of the various embodiments. In this example, the device includes at least one processor 1102 for executing instructions that can be stored in a memory device or element 1104. As would be apparent to one of ordinary skill in the art, the device can include many types of memory, data storage or computer-readable media, such as a first data storage for program instructions for execution by the processor 1102, the same or separate storage can be used for images or data, a removable memory can be available for sharing information with other devices, and any number of communication approaches can be available for sharing with other devices. The device typically will include some type of display element 1106, such as a touch screen, organic light emitting diode (OLED) or liquid crystal display (LCD), although devices such as portable media players might convey information via other means, such as through audio speakers. As discussed, the device in many embodiments will include at least communication component 1108 and/or networking components 1110, such as may support wired or wireless communications over at least one network, such as the Internet, a local area network (LAN), Bluetooth®, or a cellular network, among other such options. The components can enable the device to communicate with remote systems or services. The device can also include at least one additional input device 1112 able to receive conventional input from a user. This conventional input can include, for example, a push button, touch pad, touch screen, wheel, joystick, keyboard, mouse, trackball, keypad or any other such device or element whereby a user can input a command to the device. These I/O devices could even be connected by a wireless infrared or Bluetooth or other link as well in some embodiments. In some embodiments, however, such a device might not include any buttons at all and might be controlled only through a combination of visual and audio commands such that a user can control the device without having to be in contact with the device.

The various embodiments can be implemented in a wide variety of operating environments, which in some cases can include one or more user computers or computing devices which can be used to operate any of a number of applications. User or client devices can include any of a number of general purpose personal computers, such as desktop or laptop computers running a standard operating system, as well as cellular, wireless and handheld devices running mobile software and capable of supporting a number of networking and messaging protocols. Such a system can also include a number of workstations running any of a variety of commercially-available operating systems and other known applications for purposes such as development and database management. These devices can also include other electronic devices, such as dummy terminals, thin-clients, gaming systems and other devices capable of communicating via a network.

Most embodiments utilize at least one network that would be familiar to those skilled in the art for supporting communications using any of a variety of commercially-available protocols, such as TCP/IP or FTP. The network can be, for example, a local area network, a wide-area network, a virtual private network, the Internet, an intranet, an extranet, a public switched telephone network, an infrared network, a wireless network and any combination thereof. In embodiments utilizing a Web server, the Web server can run any of a variety of server or mid-tier applications, including HTTP servers, FTP servers, CGI servers, data servers, Java servers and business application servers. The server(s) may also be capable of executing programs or scripts in response requests from user devices, such as by executing one or more Web applications that may be implemented as one or more scripts or programs written in any programming language, such as Java®, C, C# or C++ or any scripting language, such as Python, as well as combinations thereof. The server(s) may also include database servers, including without limitation those commercially available from Oracle®, Microsoft®, Sybase® and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch-sensitive display element or keypad) and at least one output device (e.g., a display device, printer or speaker). Such a system may also include one or more storage devices, such as disk drives, optical storage devices and solid-state storage devices such as random access memory (RAM) or read-only memory (ROM), as well as removable media devices, memory cards, flash cards, etc.

Such devices can also include a computer-readable storage media reader, a communications device (e.g., a modem, a network card (wireless or wired), an infrared communication device) and working memory as described above. The computer-readable storage media reader can be connected with, or configured to receive, a computer-readable storage medium representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs such as a client application or Web browser. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and other non-transitory computer readable media for containing code, or portions of code, can include any appropriate media known or used in the art, such as but not limited to volatile and non-volatile, removable and non-removable media implemented in any method or technology for storage of information such as computer readable instructions, data structures, program modules or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices or any other medium which can be used to store the desired information and which can be accessed by a system device. Based on the disclosure and teachings provided herein, a person of ordinary skill in the art will appreciate other ways and/or methods to implement the various embodiments

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A computer-implemented method, comprising:
receiving a source image including a representation of a source object having a visual aspect;
receiving indication of a class of target images including representations of a plurality of target objects;
inferring, using an encoder network, a content code for the source image, the content code representing the visual aspect; and
inferring, using a decoder network, a set of translation images representing a selection of the target objects having the visual aspect, the decoder network receiving as input the content code for the source object and style codes for the target objects inferred from a second encoder network, the style codes corresponding to appearance styles of the target objects.

2. The computer-implemented method of claim 1, further comprising:
representing the appearance styles of the target objects as affine transformation parameters in normalization layers of the decoder network.

3. The computer-implemented method of claim 1, further comprising:
generating, from the style codes and using multilayer perceptrons, parameters for adaptive instance normalization layers of the decoder network.

4. The computer-implemented method of claim 1, further comprising:
inferring, using a second encoder network, a style code for the source object, the style code representing the appearance style of the source object; and
re-constructing the source image using the content code and the style code to determine a loss value associated with the content code.

5. The computer-implemented method of claim 1, further comprising:
training the decoder network for a population of objects of the class, the population represented by a Gaussian distribution from which the selection of the target objects can be sampled.

6. A computer-implemented method, comprising:
receiving a digital representation of an image including a first object having a visual aspect; and
inferring, using a neural network, a set of output images representing other objects having the visual aspect, the neural network receiving as input the visual aspect and style data for the other objects.

7. The computer-implemented method of claim 6, further comprising:
inferring, using a target encoder network, the style data for the other objects, the style data for the other objects including style codes corresponding to respective points in style space, the style space corresponding to a distribution of objects in a class of objects.

8. The computer-implemented method of claim 7, further comprising:
inferring, using a source encoder network, a content code representative of the visual aspect for the first object, the content code and the style codes for the target objects being provided as input to the neural network.

9. The computer-implemented method of claim 7, further comprising:
inferring, using a second encoder network, a style code for the source object, the style code representing an appearance style of the source object; and
performing regularization by re-constructing the source image using the content code and the style code.

10. The computer-implemented method of claim 6, wherein the neural network has not processed previously-received images including the other objects represented as having the visual aspect.

11. The computer-implemented method of claim 6, further comprising:
representing the style data for the target objects as affine transformation parameters in normalization layers of the neural network.

12. The computer-implemented method of claim 6, further comprising:
generating, from the style data and using multilayer perceptrons, parameters for adaptive instance normalization layers of the neural network.

13. The computer-implemented method of claim 6, further comprising:
selecting the other objects from a class of objects using random sampling of a multi-variate Gaussian distribution.

14. The computer-implemented method of claim 6, wherein the neural network is a generative adversarial network (GAN) including a conditional image generator and an adversarial discriminator.

15. The computer-implemented method of claim 14, further comprising:
normalizing, by a normalization layer of the adversarial discriminator, layer activations to zero mean and unit variance distribution; and
de-normalizing the normalized layer activations using an affine transformation.

16. A system, comprising:
at least one processor; and
memory including instructions that, when executed by the at least one processor, cause the system to:
receive a digital representation of an image including a first object having a visual aspect; and
infer, using a neural network, a set of output images representing other objects having the visual aspect, the neural network receiving as input the visual aspect and style data for the other objects.

17. The system of claim 16, wherein the instructions when executed further cause the system to:
infer, using a target encoder network, the style data for the other objects, the style data for the other objects including style codes corresponding to respective points in style space, the style space corresponding to a distribution of objects in a class of objects.

18. The system of claim 17, wherein the instructions when executed further cause the system to:
infer, using a source encoder network, a content code representative of the visual aspect for the first object, the content code and the style codes for the target objects being provided as input to the neural network.

19. The system of claim 16, wherein the instructions when executed further cause the system to:
represent the style data for the target objects as affine transformation parameters in normalization layers of the neural network.

20. The system of claim 16, wherein the instructions when executed further cause the system to:
generate, from the style data and using multilayer perceptrons, parameters for adaptive instance normalization layers of the neural network.
